(19) United States
(12) Patent Application Publication
(10) Pub. No.: US 2025/0129868 A1
(43) Pub. Date: Apr. 24, 2025

(54) Sensor Adaptor for Flange

(71) Applicant: Schlumberger Technology Corporation, Sugar Land, TX (US)

(72) Inventors: Linyuan Zhan, Singapore (SG); Arun Cherian Varkey, Pune (IN); Ruslan Kozmenko, Singapore (SG); Jethro Low, Singapore (SG); Mengke Zhan, Singapore (SG); Ayush Moitra, Singapore (SG)

(21) Appl. No.: 18/919,490

(22) Filed: Oct. 18, 2024

(30) Foreign Application Priority Data
Oct. 20, 2023 (IN) 202311071703

(51) Int. Cl. F16L 41/00

(52) U.S. Cl. CPC F16L 41/008

(57) ABSTRACT

Systems, methods, and devices are provided for a removable sensor adaptor for an end flange of a blind tee. Such a system may include a flange to be installed on a blind tee conduit and a removable sensor adaptor to be installed in the end flange. The sensor adaptor may be removed from the flange without removing the flange from the blind tee.

This application claims the benefit of India patent application Ser. No. 20/231,1071703 filed on Oct. 20, 2023, and is hereby incorporated by reference in its entirety.

### BACKGROUND

This disclosure relates to a removable adaptor to embed a sensor in a flange to enable the sensor to be removed by removing the adaptor from the flange without removing the entire flange.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, these statements are to be read in this light, and not as an admission of any kind.

Numerous fluid processing systems use sensors to determine properties of the fluids flowing through them. For example, some fluid systems in oil and gas production reclaim hydrate inhibitors, such as monoethylene glycol (MEG). Hydrate inhibitors are sometimes used in oil and gas wells with co-produced water to reduce or eliminate methane hydrate formation, especially in oil and gas wells that experience high pressures and low temperatures, such as subsea wells with long subsea flowlines. However, hydrate inhibitors are expensive in relation to other chemicals used in producing and operating oil and gas wells. Accordingly, hydrate inhibitors reclamation systems are used to reclaim and reuse hydrate inhibitors in the oil and gas well to reduce operating costs.

At various points within a hydrate inhibitor reclamation system, the hydrate inhibitor, such as MEG, may be mixed with water of a salinity to form an aqueous liquid that is pre-separated from co-produced hydrocarbons oil and gas. Being able to determine the hydrate inhibitor concentration and salinity of the aqueous liquid flowing through various locations of the hydrate inhibitor MEG reclamation system is therefore highly desired to improve the operation and efficiency of hydrate inhibitor reclamation systems. There is also a benefit to measuring on-line, before the MEG pre-separation process, the mass fraction of the injected MEG contained in water co-produced with the oil and gas fluids, and to measure produced water salinity. These measurements are useful to avoid over-injecting MEG (and corrosion inhibitors) in produced water and hence to save oil-gas production cost. Sensors are sometimes embedded into a flange of a blind tee pipe configuration to monitor fluid properties. For larger pipes, the correspondingly large flange may take a significant amount of time and labor to be removed or replaced. Calibrating a sensor may entail placing the sensor in contact with one or more reference fluids and obtaining reference fluids measurements before returning the sensor to the fluid of interest. Thus, calibrating a sensor by removing and replacing a large flange with an embedded sensor may be a significant time-and labor-intensive process.

### SUMMARY

A summary of certain embodiments disclosed herein is set forth below. These aspects are presented merely to provide the reader with a brief summary of these certain embodiments and that these aspects are not intended to limit the scope of this disclosure. Indeed, this disclosure may encompass a variety of aspects that may not be set forth below.

The disclosed apparatus, systems, and methods are directed to a removable adaptor for a sensor to be embedded in a flange installed on a pipe. The adaptor holding the sensor may be removed from the flange for calibration or maintenance without removing the flange from the pipe. This saves a tremendous amount of time and labor and allows for more efficient calibration. Moreover, a sensor may be swapped without replacing an entire flange. The sensor may be used, for example, to determine a concentration of a hydrate inhibitor, such as monoethylene glycol (MEG) and, in some cases, a salinity in a MEG-water aqueous liquid co-flowing with produced oil and gas through a conduit. Though this disclosure includes systems and apparatus described as applied to a hydrate inhibitor injection and/or reclamation system of an oil and gas well, the disclosed techniques may be utilized in other applications, including other uses of hydrate inhibitors. Moreover, any suitable sensor, such as an electromagnetic (EM) sensor (e.g., a dielectric permittivity sensor, a microwave transmission sensor, a microwave reflection sensor, a photonic or optical sensor such as a camera, an infrared spectroscopic sensor), an electrical sensor, a temperature sensor, or other type of sensor, may be installed in a removable adaptor for a flange.

For example, an electromagnetic (EM) microwave open-ended coaxial probe may be used to measure the dielectric properties of a multiphase-flow mixture to infer the liquid properties, such as salinity and/or mass fraction of a hydrate-inhibitor (e.g., mono-ethylene-glycol or MEG) of the aqueous phase. To improve the measurement of liquid properties under multiphase flow conditions, especially for very high gas fraction flow in large pipe sizes such as 10-40 inch in diameter, an end flange design may include a removable adaptor at the end of a horizontal blind tee to install the microwave coaxial probe. The end flange may be a blind flange that matches the mating flange on a horizontal blind tee. A step hole with sealing surfaces is formed in the end flange for the removable adaptor, on which the coaxial probe will be installed at a desired liquid-rich location in the horizontal blind tee. In between the components, the gaps may be sealed by elastomer or metal seals to retain pressure. The location of the step hole on the end flange may be at the lower part of the horizontal blind tee where it has been discovered to have high local liquid richness. The removal adaptor enables a simpler calibration process of the reflection probe by avoiding dismantling the entire end flange.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a fluid velocity map of a blind tee structure, illustrating that fluid velocity is lower in the blind end of the blind tee;

FIG. 2 is a cross-sectional view of a conduit structure having a blind tee structure and a sensor embedded in a removable adaptor in a flange on the blind tee;

FIG. 3 is a cross-sectional view of the adaptor embedded in the flange of FIG. 2;

FIG. 4 is a flowchart of a method for calibrating a sensor in the adaptor without removing the flange from the blind tee; and

FIG. 5 is another cross-sectional view of the adaptor embedded in the flange of FIG. 2 including a reference sensor.

### DETAILED DESCRIPTION

One or more specific embodiments will be described below. To provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Numerous fluid processing systems use sensors to determine properties of the fluids flowing through them that may benefit from a sensor embedded in an adaptor in a flange. Indeed, some fluid systems in oil and gas production reclaim hydrate inhibitors, such as monoethylene glycol (MEG) or methanol. At various points within a hydrate inhibitor reclamation system, the hydrate inhibitor, such as MEG, may be mixed with water of a salinity to form an aqueous liquid that is pre-separated from co-produced hydrocarbons oil and gas. Being able to determine the hydrate inhibitor concentration and salinity of the aqueous liquid flowing through various locations of the hydrate inhibitor MEG reclamation system is therefore highly desired to improve the operation and efficiency of hydrate inhibitor reclamation systems. There is also a benefit to measuring on-line, before the MEG pre-separation process, the mass fraction of the injected MEG contained in water co-produced with the oil and gas fluids, and to measure produced water salinity. These measurements are useful to avoid over-injecting MEG (and corrosion inhibitors) in produced water and hence to save oil-gas production cost. However, there are many other fluid systems that may benefit from a sensor embedded in an adaptor in a flange. Because the adaptor holding the sensor may be removed from the flange for calibration or maintenance without removing the flange from the pipe, this may save a tremendous amount of time and labor. Any suitable sensor, such as an electromagnetic (EM) sensor (e.g., a dielectric permittivity sensor, a microwave transmission sensor, a microwave reflection sensor, a photonic or an optical sensor such as a camera, an infrared spectroscopic sensor), an electrical sensor, a temperature sensor, or other type of sensor, may be installed in a removable adaptor for a flange.

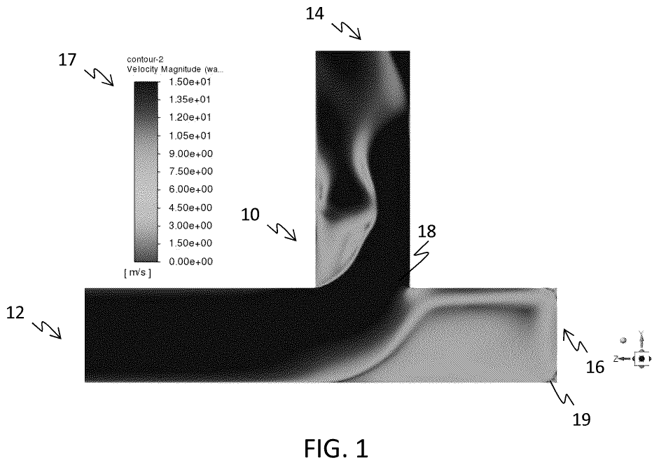

In many fluid processing systems, fluid properties may be measured at a blind tee capped by a flange. The fluid dynamics of a production line horizontal blind tee conduit 10 are shown in FIG. 1. In particular, FIG. 1 illustrates a Computational Fluid Dynamics (CFD) analysis with assumptions of very high gas fraction flow in large pipe sizes such as a 10-40-inch pipe. The blind tee conduit 10 has a horizontal inlet aperture 12 and a vertical outlet aperture 14 through which fluid flows. A horizontal aperture 16 is blocked (as an end blind tee) by a flange and thus does not permit fluid to flow through the aperture 16. As represented by a legend 17, fluid velocity is highest between the apertures 12 and 14, such as in a region 18. Fluid has a comparatively much lower velocity at a region 19 in the lower part of the blind tee conduit 10 near the aperture 16 that is blocked by a flange. It can be seen that near the bottom and the top corner of the blind tee conduit 10 end, the flow velocity is significantly lower than the mainstream at region 18. Hence liquid deposition is more likely in the pipe bottom low velocity (slow recirculation) region 19.

The lower velocity of the region 19 thus facilitates fluid measurement. Any suitable sensors may be installed and measure fluid properties near the region 19. For example, an electromagnetic (EM) sensor measurement based on microwave reflection may be used. This type of measurement is a local measurement. To obtain good measurement of the liquid properties, the installation location of the EM/microwave reflection sensor (or probe) may be selected in a region that is liquid rich. Here, it is shown that at the lower half of the end flange of the horizontal blind tee configuration 10 near region 19, there is more liquid than in the mainstream near region 18 due to the lower velocity of the fluid near region 19. Accordingly, as will be discussed further below, a sensor may be placed near the bottom of the pipe at liquid-rich region 19 to handle very high gas content flow.

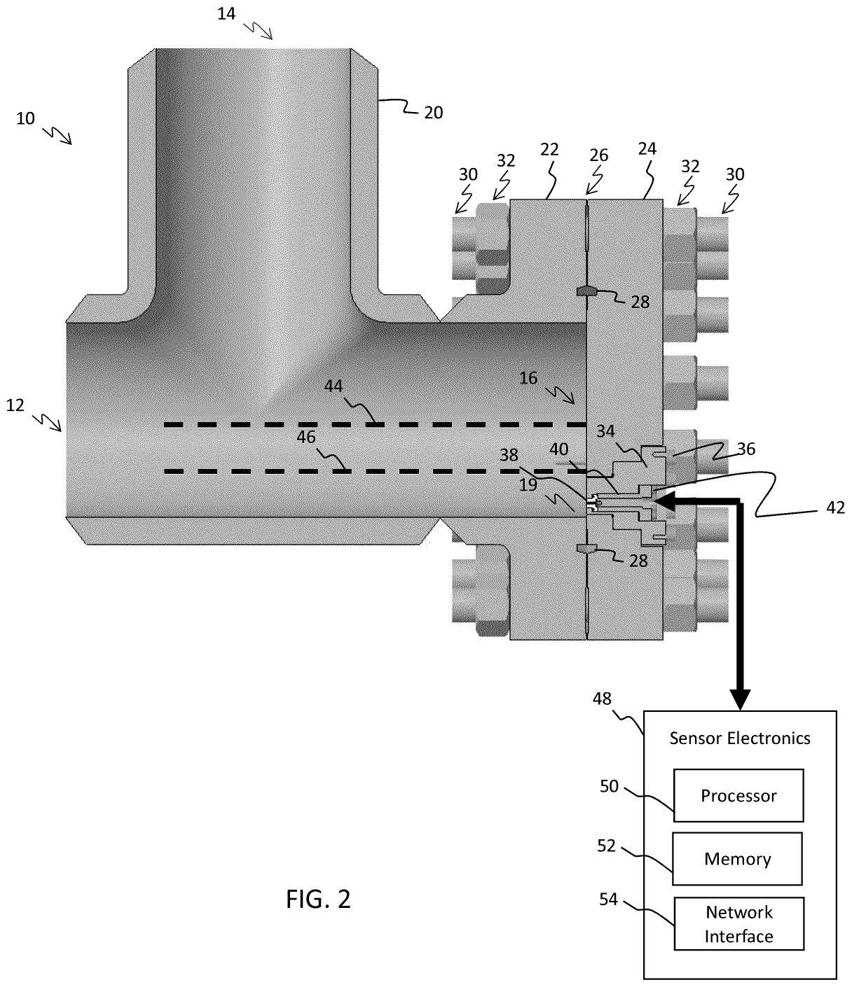

FIG. 2 illustrates a cross-sectional mechanical design of the blind tee conduit 10, including the apertures 12, 14, and 16. The apertures 12 and 14 are open to additional conduit, whereas a portion of the blind tee conduit 10 near the aperture 16 includes a mating flange 22 to which an end flange 24 may be attached. Sealing surfaces 26 press together and may additionally make use of a gasket 28 to block fluid from exiting the aperture 16 when bolts 30 and nuts 32 are tightened, pressing the end flange 24 to the mating flange 22.

A removable sensor adaptor 34 may be bolted into the end flange 24 using bolts 36. The bolts 36 may be much smaller and may involve much less labor and time to install or remove than the nuts 32 and bolts 30 of the mating flange 22 and end flange 24. Indeed, the bolts 36 may be a fraction of the size of the nuts 32 and bolts 30 of the mating flange 22 and end flange 24 (e.g., 50%, 40%, 30%, 25%, 20%, 15%, 10%, 5%, or less). Moreover, the adaptor 34 may itself be much smaller than the end flange 24 (e.g., a diameter of 50%, 40%, 30%, 25%, 20%, 15%, 10%, 5%, or less than the end flange 24). A sensor 38 supported by a sensor housing 40 may be installed in the adaptor 34. The sensor 38 may measure fluid properties near the region 19 of the blind tee conduit 10. The sensor housing 40 may be installed in the adaptor using still smaller fasteners 42 (e.g., bolts, screws, adhesive). By way of example, the sensor 38 may be an electromagnetic (EM) sensor of the type described in U.S. Pat. Nos. 11,733,420 or 9,645,130 which are incorporated by reference in their entireties for all purposes.

As seen in FIG. 2, the adaptor 34 may be eccentered in the end flange 24 to allow the sensor 38 to be closer to the region 19 than if the adaptor 34 were centered in the end flange 24. For instance, the adaptor 34 may be installed beneath a horizontal centerline 44. In some cases, the adaptor 34 (e.g., a surface of the adaptor 34 on which the sensor 38 is disposed near the fluid at the region 19) may be installed beneath a horizontal quarter line 46 representing one-quarter the diameter of the aperture 16. What is more, the sensor 38 may be fully within the aperture 16 while part of the adaptor 34 is lower in the end flange 24, disposed at substantially the same height as the sealing surfaces 26.

The sensor 38 may communicate with sensor electronics 48 via an appropriate electrical cable, which may include a processor 50, memory 52, and/or a network interface 54. The sensor electronics 48 may transmit a signal to the sensor 38, receive and process raw data from the sensor 38 to produce a signal that may correspond to fluid properties in the blind tee configuration 10. For example, the sensor electronics 48 may enable calibration of the sensor 38 in contact with one or more reference fluids when the adaptor 34 is removed.

The processor 50 may include one or more microprocessors to execute instructions stored in the memory 52 or other accessible locations. The processor 50 may, additionally or alternatively, include application-specific integrated circuit (ASIC), field-programmable gate array (FPGA), and/or other devices designed to perform functions discussed herein. As will be appreciated, multiple processors 50 or processing components may be used to perform functions discussed herein in a distributed or parallel manner. The memory 52 may encompass any suitable tangible, non-transitory medium for storing data or executable routines. Although shown for convenience as a single block in FIG. 2, the memory 52 may encompass various discrete media in the same or different physical locations. The network interface 54 may be used to transfer data to other computing systems such as a local or remote computer that may enable an operator to view the fluid properties or a component of the fluid processing system to adjust the operation of the fluid processing system. In some cases, the sensor electronics 48 or the local or remote computer may generate a control signal to control the fluid processing system based on the fluid properties.

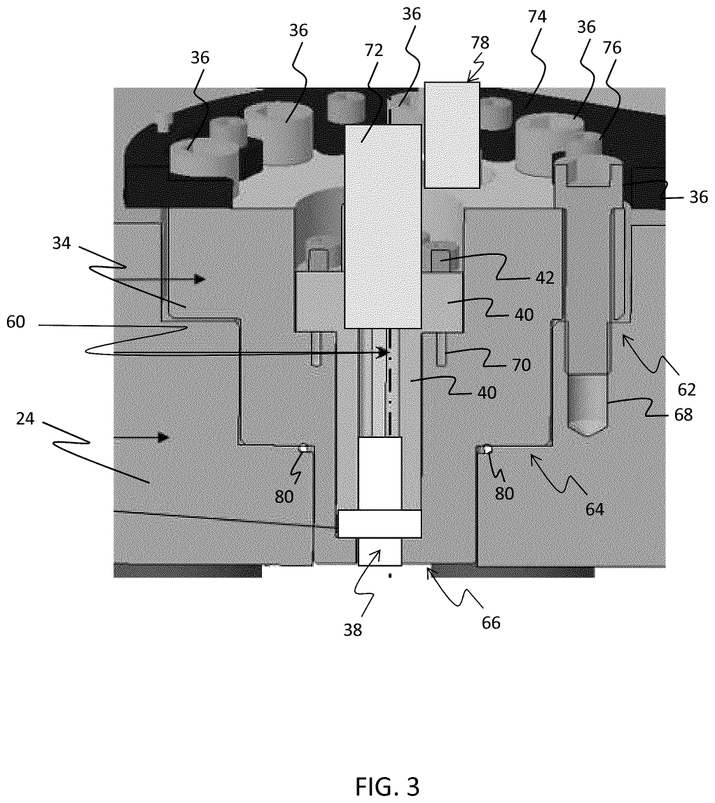

FIG. 3 is a cross-sectional perspective view of the adaptor 34 mated within the end flange 24. As shown in FIG. 3, the sensor 38 and sensor housing 40 may be eccentered within the adaptor 34 (e.g., may be installed offset from a centerline 60 of the adaptor 34). Being eccentered, the installation orientation of the adaptor 34 within the end flange 24 can be changed by rotating the adaptor 34; in this way, the sensor 38 position in the end flange 24 can be adjusted.

The adaptor 34 may have a main body having a tiered structure in which a first portion 62 has a first diameter, a second portion 64 has a second diameter smaller than the first diameter, and a fluid-interface surface 66 has a third diameter smaller than the second diameter. This tiered structure allows the bolts 36 to fit through bores 68 in the first portion 62 and in a step hole formed in the end flange 24. The second portion 64 allows the fasteners 42 to fit through the adaptor 34 within the second portion 64 into bores 70 to secure the sensor housing 40 to the adaptor 34. Moreover, the smaller diameter of the third portion 66 reduces the amount of pressure applied to the surface of the adaptor 34 by fluid in the blind tee conduit. The main body of the adaptor 34 may be formed using any suitable material (e.g., steel, Inconel) that may depend, for example, on the temperature and pressure of the fluid in the fluid processing system that includes the blind tee conduit 10. A cable gland 72 may support a cable (not shown) from the sensor 38 out to the sensor electronics 48 shown in FIG. 2. A bracket 74 held to the adaptor 34 by fasteners 76 (e.g., bolts, screws, adhesive) may hold the sensor electronics shown in FIG. 2. A reference sensor 78 is shown in a different location within the adaptor 34. The reference sensor 78 may not operate as a probe in contact with the fluid like the sensor 38, but rather may obtain reference measurements to remove drift effects in the sensor 38 due to ambient conditions (e.g., cable's phase-shift changes in temperature, or other conditions) in the adaptor 34. The adaptor 34 may include a seal 80, such as an elastomer or metal O-ring seal, to seal the surfaces of the adaptor 34 and the end flange 24.

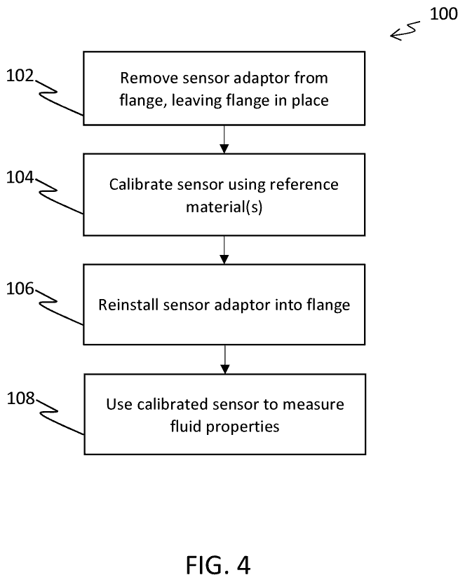

The adaptor may enable a much more efficient calibration or replacement of the sensor in the end flange. Indeed, operating an EM sensor may entail calibration and testing with various liquid samples in front of the coaxial probe of the sensor. To access the probe, the adaptor can be uninstalled instead of uninstalling the larger end flange, which entails much more time and labor. For example, as shown by a flowchart 100 of FIG. 4, the sensor may be removed from the end flange without removing the end flange (block 102). This may save a tremendous amount of time and labor. With the adaptor having been removed from the end flange, the sensor may be calibrated in one or more reference fluids while the end flange remains in place (block 104). Following the calibration of the sensor, the adaptor may be reinstalled into the end flange (block 106) and the calibrated sensor may be used to measure fluid properties of the process fluids (block 108). The measured fluid properties, such as hydrate inhibitor (e.g. MEG) mass concentration in water and water salinity, may be used by an operator or an automated control system to control any desired aspects of the fluid processing system that are affected by the fluid properties, such as to improve (e.g., optimize) the injection rate of a hydrate inhibitor or a corrosion inhibitor, to avoid over-dosing chemical injection fluids (to reduce oil-gas production cost) or avoid under-dosing (to prevent unwanted interruption to oil-gas production). The accurate measurement of aqueous fluid properties facilitates adequate chemical injection that is particularly valuable to ensuring flow assurance during the shut-down or start-up process of oil-gas wells.

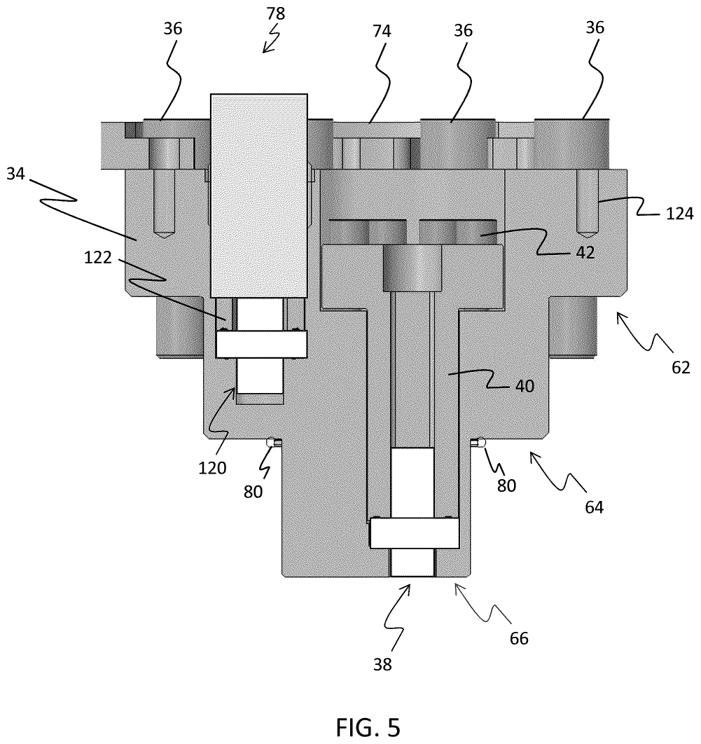

Another cross-sectional side view of the adaptor 34 is shown in FIG. 5. Elements that have been described with reference to other drawings are not described further here. In the example of FIG. 5, the position of the reference sensor 78 within the adaptor is shown. A reference sensor 120 measures the property of a known (reference) fluid (such as a dry gas). The reference sensor 78 has an electrical cable phase-matched to the electrical cable of the sensor 38 (not shown) that may be encased within or around the adaptor 34 and, as such, may be impacted (in cables' phase-shift) by ambient conditions (e.g., temperature) that may affect equally a reference signal by which to compensate the measurement signal obtained by the sensor 38, since it is expected that the sensor 38 will experience similar phase-shift drift under similar ambient conditions. The fasteners 76 that hold the bracket 74 to the adaptor 34 may attach to the adaptor 34 through bores 124 in the adaptor 34.

The specific embodiments described above have been shown by way of example, and these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible, or purely theoretical.

Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system comprising:
an end flange configured to be installed on a blind tee conduit; and
a removable sensor adaptor configured to be installed in the end flange.

2. The system of claim 1, wherein the end flange comprises a step hole within which the removable sensor adaptor is configured to be installed.

3. The system of claim 2, wherein the step hole is eccentered in the end flange within which the removable sensor adaptor is configured to be installed at the bottom liquid-rich part of the blind tee conduit.

4. The system of claim 1, wherein the removable sensor adaptor comprises a plurality of fasteners to removably couple the removable sensor adaptor to the end flange.

5. The system of claim 4, wherein the plurality of fasteners are configured to enable the removable sensor adaptor to be removed from the end flange while the end flange is installed on the blind tee conduit.

6. The system of claim 1, wherein the removable sensor adaptor comprises a step hole into which a sensor is disposed.

7. The system of claim 1, wherein the removable sensor adaptor comprises a sensor that is eccentered in the removable sensor adaptor.

8. The system of claim 1, wherein the sensor adaptor comprises a plurality of sensors, at least one of which is configured to probe a fluid in contact with the end flange and at least one of which is configured to probe a reference fluid not in contact with the end flange.

9. The system of claim 1, wherein the sensor adaptor comprises an electromagnetic (EM) sensor.

10. A method comprising:
removing a sensor adaptor comprising a sensor from an end flange installed on a blind tee;
calibrating the sensor while the sensor adaptor is removed from the end flange; and
reinstalling the sensor adaptor into the end flange.

11. The method of claim 10, wherein the sensor adaptor is removed without removing the end flange.

12. The method of claim 10, wherein removing the sensor adaptor comprises removing first fasteners attaching the sensor adaptor to the end flange that are smaller than second fasteners attaching the end flange to the blind tee.

13. The method of claim 10, wherein removing the sensor adaptor comprises removing first fasteners attaching the sensor adaptor to the end flange that are fewer in number than second fasteners attaching the end flange to the blind tee.

14. The method of claim 10, comprising using the calibrated sensor to measure fluid properties of a fluid in the blind tee.

15. A sensor adaptor for an end flange comprising:
a main body comprising:
a step hole configured to hold a sensor;
a first portion having a first diameter;
a second portion having a second diameter smaller than the first diameter; and
a plurality of bores that extend through the first portion to enable a first set of fasteners to attach the sensor adaptor to the end flange.

16. The sensor adaptor of claim 15, wherein the step hole is eccentered in the sensor adaptor.

17. The sensor adaptor of claim 15, comprising a sensor disposed in the step hole of the main body.

18. The sensor adaptor of claim 17, wherein the main body comprises a second sensor bore not formed in a step hole shape, wherein the sensor adaptor comprises a reference sensor disposed in the second sensor bore.

19. The sensor adaptor of claim 15, wherein the sensor adaptor comprises a sensor housing comprising a first portion having a third diameter and a second portion having a fourth diameter smaller than the third diameter, wherein the sensor housing comprises another plurality of bores through the first portion of the sensor housing to enable a second set of fasteners to attach the sensor housing to the main body of the sensor adaptor.

20. The sensor adaptor of claim 19, wherein the second set of fasteners are smaller or fewer in number than the first set of fasteners.
